(19) United States
(12) Patent Application Publication
(10) Pub. No.: US 2007/0138708 A1
(43) Pub. Date: Jun. 21, 2007

(54) Method for producing filter used in gas generating apparatus of car airbag

(76) Inventors: Dong-kyu Park, Busan (KR); Kang-chul Jung, Gyeongsangnamdo (KR); Yong-hee Lee, Gyeongsangnamdo (KR); Se-hoon Seok, Gyeongsagnamdo (KR); Jean-suk Surh, Daejeon (KR)

Correspondence Address: WENDEROTH, LIND & PONACK, L.L.P., 2033 K STREET N. W., SUITE 800, WASHINGTON, DC, 20006-1021, US

(21) Appl. No.: 11/596,892

(22) PCT Filed: Oct. 28, 2006
(86) PCT No.: PCT/KR05/03614

§ 371 Date: Nov. 17, 2006

(30) Foreign Application Priority Data
Nov. 29, 2004 (KR) 10-2004-0098910
Mar. 21, 2005 (KR) 10-2005-0023047

(51) Int. Cl. C04B 35/64

(52) U.S. Cl. 264/603; 264/628; 264/37.1

(57) ABSTRACT

The present invention relates to a filter used in a gas generating apparatus of a car airbag. The car airbag is equipped with a gas generating apparatus for generating high temperature and high pressure, in which gunpowder is exploded by ignition of an igniter, by which a gas generating agent is burned. By combustion of a gas generating agent, a high temperature and high pressure gas is generated, which should be cooled down to be suitable for expansion of an airbag while impurities contained in the gas are removed. The present invention relates to a filter prepared by sintering a perforate plate with metal powder prepared by processing machining chips to meet the foregoing requirements. The filter according to the present invention is prepared by preparing a perforated plate in a cylinder form by uniformly forming holes of 1 to 8 mm on a metal plate using a frame mold and rolling up the plate, preparing metal powder of 20 to 50 mesh by processing machining chips, placing the perforated plate in a molder and vibration packing the metal powder to be uniformly distributed, and sintering the metal powder at 1000 to 1350° C. for 15 to 120 minutes.

### TECHNICAL FIELD

The present invention relates to a filter used in a gas generating apparatus of a car airbag. The car airbag is equipped with a gas generating apparatus for generating high temperature and high pressure, in which gunpowder is exploded by ignition of an igniter, by which a gas generating agent is burned. By combustion of a gas generating agent, a high temperature (1670° C.) and high pressure (60 MPa) gas is generated. The gas should be cooled down to be suitable for expansion of an airbag while impurities contained in the gas are removed. The present invention relates to a filter prepared by sintering a perforate plate with metal powder prepared by processing machining chips to meet the foregoing requirements.

### BACKGROUND ART

Conventionally used filter materials include iron net, metal fabric and metal fiber for suitable heat resistance and heat capacity, which are laminated in a cylindrical form or press-formed. However, these materials cannot be used alone due to their poor compression strength and thus, a metal net cylinder (expand metal) using various thick linear metallic materials is disposed inside of the cylinder or sintered along with the filter to improve strength.

That is, the aggregate of tangled metal filaments forming the iron net or a metallic fabric and metal fiber takes the charge of slag filtration and the metal net takes the charge of reinforcement to improve pressure resistance of the filter.

The convention metal filament aggregate for filtration of slag is formed of metal filaments with a small heat capacity per unit length. Also, since its heat conduction accomplished by contact, when a high temperature gas topically drifts, the metal filaments may be instantly melted and if excessive, the filter may be melted to form an opening.

Therefore, it is a critical factor in preparation of a filter to adjust fineness of the micro metal filament aggregate.

However, in a long cylindrical gas generating apparatus, a long filter corresponding to the length of the apparatus is needed. When the filter is prepared using metal filament aggregates, the aggregates are compressed for fineness.

Here, since the compression may produce density differences among the upper, middle and lower parts, it is difficult to prepare a filter with uniform density. Also, since the filter is prepared by simply pressing wires without bonding, its partial size may be changed by an external pressurization.

Also, there is a filter prepared using only a perforated plate without metal filament. However, when the perforated plate is rolled up to form a cylindrical structure, pores may be overlapped or obstructed. As a result, it is not easy to control the pores, causing non-uniformity of fluidity. Further, the plate should be excessively rolled up to prevent flame from escaping from the inside, increasing the total weight of the filter.

Meanwhile, as the number of airbags installed in automobiles is recently increased, the total weight of components installed in the airbags is considered critical.

### DISCLOSURE OF INVENTION

### Technical Problem

Accordingly, the present invention has been made to solve the above-mentioned problems occurring in the prior art, and it is an object of the present invention to provide a filter comprising inside a perforated plate with excellent strength and outside metal powder with a suitable size, sintered at a predetermined temperature, so that the filter has suitable strength, heat conductivity and heat resistance. According to the present invention, upon forming of the filter, the powder is packed by vibration and sintered at a low pressure to reduce the weight of the filter. Also, it is possible to make the density of the metal powder uniform through the filter when the filter has a long length.

### Technical Solution

To accomplish the above objects of the present invention, according to the present invention, there is provided a filter with strength and heat conduction property suitable for a gas generating apparatus, prepared by forming a cylindrical structure having a perforated plate or broad net of 20 mesh or more with excellent strength as an inner element and metal powder with large surface area as an outer element and sintering the structure.

The inner perforated plate or broad net serves to remove large size slag and stand for the impact caused by combustion of a gas generating agent. The outer metal powder layer has a proper size, unlike fine metal filament, and facilitates heat conduction due to its large surface area, without forming large holes by combustion heat. The metal powder layered structure makes the exhaust passage of the combustion gas complex to increase heat conductance efficiency and facilitate removal of fine slag.

### Advantageous Effects

According to the present invention, it is possible to reduce production cost by preparing the metal powder used in the filter using machining chips. Also, since the powder is packed and sintered at a low pressure, it is possible to reduce density of the metal powder, to improve air permeability of the filter and to lighten the filter.

Particularly, by using cast iron machining chips, the sintering may be performed at a temperature of 1170° C. or less using a normal furnace of a mesh belt type, whereby it is possible to mass-produce the filter.

### BRIEF DESCRIPTION OF THE DRAWINGS

FIG. 1 is a perspective view of the gas generating apparatus using the filter according to the present invention;

FIG. 2 is a cross-sectional view of the filter according to the present invention;

FIG. 3 is a perspective view of the net used in the filter according to the present invention;

FIG. 4 is a perspective view of the filter according to the present invention;

FIG. 5 is a cross-sectional view of the gas generating apparatus equipped with the filter according to the present invention; and

FIG. 6 is a cross-sectional view of the gas generating apparatus according to another embodiment of the present invention.

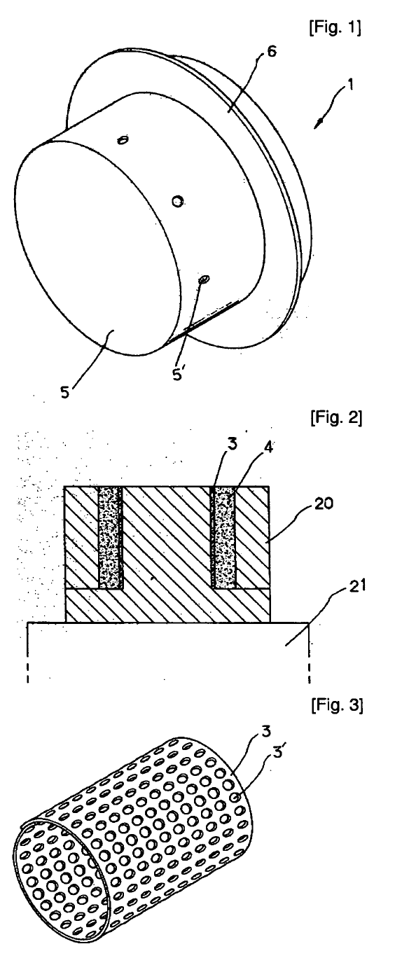

### BEST MODE FOR CARRYING OUT THE INVENTION

Now, the construction and operation of the filter according to the present invention will be described in detail with reference to the drawings.

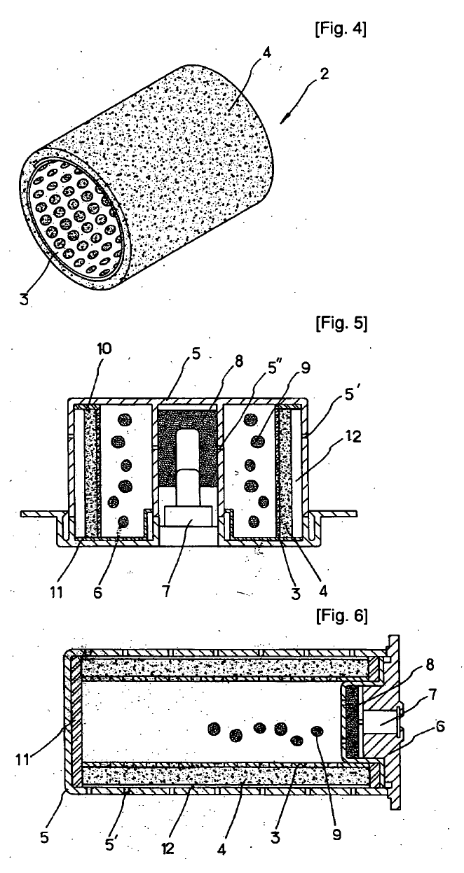

As shown in FIG. 2 to FIG. 4, the filter 2 comprises an inner metallic perforated plate 3 and outer sintered metal powder 4.

The perforated plate 3 may be located in the outside or the middle of the metal powder 4, as needed and its length is mostly the same as the length of metal powder 4 but may be different.

In FIG. 5, a gas generating apparatus 1 is shown to have a main body 5 with holes 5 circumferentially formed thereon and a sub-body 6, through which the main body 5 is inserted to form a single body. Packings 10, 11 and a filter 2 comprising a perforated plate 3 and metal powder 4 are installed within the bodies 5, 6.

A gas generating agent 9 and gun powder 8, and an igniter 7 are installed within the filter 2.

By ignition of the igniter 7, the gun powder 8 is exploded and flame burns the gas generating agent 9 through holes 5″.

By the combustion of the gas generating agent 9, a high temperature and high pressure gas is generated. The gas is then transferred to a space 12 through the filter 2 and bursts out of the gas generating apparatus 1 through the holes 5′ to inflate an airbag.

The high temperature and high pressure gas generated by the combustion of the gas generating agent 9 should be cooled to a temperature suitable for inflation of the airbag and have impurities such as slag removed.

The filter 2 is used to satisfy the foregoing requirements and thus, is formed of material that has a proper strength and ability to provide uniform heat conduction.

The present invention is to produce such a suitable filter for the above-described requirements. The filter 2 according to the present invention employs the perforated plate 3 to maintain a suitable strength and is packed with the metal powder 4 at a uniform density to provide uniform heat conduction and remove slag.

Now, the filter according to the present invention will be described.

1. Preparation of Perforated Plate

The metallic perforated plate 3 is prepared by perforating a metal plate with a frame mold to form a perforated plate having holes with a diameter of about 1 to 80 so that it has a suitable strength and provides uniform heat conduction. The perforated plate is rolled up 1 to 2 times and welded to form the perforated plate 3 in a cylindrical shape.

The metallic perforated plate 3 may be prepared by rolling up the perforated plate 3 times or more but the weight is increased and the holes are overlapped with each other, causing obstruction of gas flow and non-uniform heat conduction.

2. Preparation of Metal Powder

The metal powder 4 which can be used in the present invention includes metal powder which is prepared by processing a metal or recycled powder which is prepared by processing machining chips. Also, the metal powder and the recycled powder may be combined in a proper mixing ratio.

The machining chips designate chips generated during processing of steel, stainless steel, cast iron and powder metallurgy products. The machining chips may be used after processing such as separation of impurities and removal of components of the cutting solution on the surface.

The commonly used method for removing the impurities and cutting solution components contained in the machining chips includes heating and solvent dipping.

The machining chips with the impurities removed are broken up to a predetermined size to form metal powder 4 with a desired diameter

When the metal powder 4 is too fine, it can be melted, like metal filament, by the combustion heat upon combustion of the gas generating agent. Also, as the powder is fine, the fluidity of the powder is poorer and the powder is coagulated with each other upon sintering, causing bridge phenomenon, by which a part is not packed with the powder.

Therefore, the metal powder 4 has suitably a size of about 10 to 100 mesh, more preferably about 20 to 50 mesh.

The machining chips of normal steel or stainless steel materials are mostly in a spiral form, not in the form of powder, because of their tenacity and carefully crushed since they have a high ductility. The machining chips produced in the processing of cast iron or powder metallurgy products are in the form of powder due to their brittleness and thus, crushed in a relatively simple way.

But, in case of cast iron powder, carbon content is high, so that it is very important to control the carbon content to get demanded mechanical properties.

The metal powder 4 prepared from the above-described machining chips has a surface area smaller than that of atomizing powder or reduced powder, newly made powder used in the powder metallurgy but has a good fluidity. Therefore, it is advantageously packed in the mold and may be subjected to a proper thermal treatment to improve surface properties and increase the surface area so that it can be used in a case needing a certain surface area.

3. Sintering

According to the present invention, the packing-forming method is used instead of the press-forming method using a press.

Generally, the packing-forming method can reduce under the density of 50%, as compared to the press-forming method.

A mold formed of a metallic or ceramic material is placed on a working die (vibration die), to which vibration is applied and the perforated plate 3 is put in the mold. The mold is packed with the metal powder 4.

When the metal powder 4 is loaded into the mold, a pore forming agent may be added in an amount of 0 to 20 wt % based on the weight of the metal powder 4 to reduce the density. If the addition of the pore forming agent causes reduction of bonding strength between the metal powder particles 4, the sintering temperature is raised or a sintering promoter is added.

The sintering promoter includes low-melting metals such as phosphorous (P), boron (B) compounds, tin (Sn) and copper (Cu) and is added in an amount of 0.5 to 20 wt % based on the total weight of the metal powder 4.

When the mold is packed with the metal powder 4, the working die is vibrated so that the packing is uniform and a pressure of 50 to 1500□/□ may be applied, as needed.

When the pressure is less than 50□/□, the pressing is to no purpose. When the pressure exceeds 1500□/□, there may occur a density difference between the upper part and the lower part.

Here, the pressing is to reduce the packing time and to level the top surface.

The mold packed with the metal powder 4 is sintered at 1000 to 1350° C. for 15 to 120 minutes.

After sintering, the filter 2 is removed from the mold and processed to a suitable size.

### MODE FOR THE INVENTION

By the above-described method, it is possible to prepare the filter having a uniform density and a lightweight and the method is illustrated using the following example.

### EXAMPLE 1

As the metal powder 4, stainless steel powder of 20 to 40 mesh and stainless steel machining chips were mixed together and evenly packed into a mold formed of a ceramic material with a stainless steel perforated plate 3 inserted by applying vibration while leveling the top surface.

The mold having the perforated plate 3 packed with the metal powder 4 was sintered for 60 minutes in a high temperature furnace of a pusher type under cracked ammonia atmosphere at 1350° C.

The table below shows properties of the filter 2 prepared using the metal powder 4 of stainless steel powder and stainless steel machining chips mixed in a weight ratio listed in the table.

| | Powder rate (wt %) | | | | | |
|---|---|---|---|---|---|---|
| | | Stainless | | | | |
| | Stainless | steel | Properties | | | |
| | steel | machining | | | Air | |
| Ex. No. | powder | chips | Packing | Strength | permeability | Note |
| 1-01 | 100 | 0 | Bad | Good | Good | |
| 1-02 | 90 | 10 | Bad | Good | Good | |
| 1-03 | 70 | 30 | Normal | Good | Good | |
| 1-04 | 50 | 50 | Good | Good | Good | |
| 1-05 | 30 | 70 | Good | Normal | Very good | |
| 1-06 | 10 | 90 | Normal | Normal | Very good | |
| 1-07 | 0 | 100 | Normal | Normal | Very good | |

### EXAMPLE 2

As the metal powder 4, powder metallurgy cutting powder (machining chips) of 20 to 40 mesh and cast iron cutting powder (machining chips) were mixed in a ratio shown in the table below and evenly packed into a mold formed of a heat resisting steel with a carbon steel perforated plate 3 inserted and a die lubricant applied by applying vibration while leveling the top surface.

The mold having the perforated plate 3 packed with the metal powder 4 was sintered for 60 minutes in a high temperature furnace of a pusher type under cracked ammonia atmosphere at 1140 to 1170° C.

The table below shows properties of the filter 2, prepared using the metal powder 4 of powder metallurgy cutting powder (machining chips) and cast iron cutting powder (machining chips) mixed in a weight ratio listed in the table.

| | Powder rate (wt %) | | | | | Note |
|---|---|---|---|---|---|---|
| | Powder | Cast | Properties | | | (Sinter- |
| | metallurgy | iron | | | Air | ing |
| Ex. | cutting | cutting | | | perme- | tempera- |
| No. | powder | powder | Packing | Strength | ability | ture) |
| 2-01 | 100 | 0 | Very good | Normal | Good | 1170° C. |
| 2-02 | 90 | 10 | Very good | Normal | Good | |
| 2-03 | 70 | 30 | Very good | Good | Good | |
| 2-04 | 50 | 50 | Very good | Good | Good | 1140° C. |
| 2-05 | 30 | 70 | Very good | Good | Good | |
| 2-06 | 10 | 90 | Very good | Very good | Good | |
| 2-07 | 0 | 100 | Very good | Very good | Good | |

### EXAMPLE 3

As the metal powder 4, powder metallurgy cutting powder (machining chips) of 20 to 40 mesh and iron powder for powder metallurgy were mixed in a ratio shown in the table below and evenly packed into a mold formed of a heat resisting steel with a stainless steel perforated plate 3 inserted and a releasing agent applied by applying vibration while leveling the top surface by applying a pressure of 50 to 1500□/□.

The mold having the perforated plate 3 packed with the metal powder 4 was sintered for 60 minutes in a high temperature furnace of a pusher type under cracked ammonia atmosphere at 1200° C.

The table below shows properties of the filter 2, prepared using the metal powder 4 of powder metallurgy cutting powder (machining chips) and iron powder for powder metallurgy mixed in a weight ratio listed in the table.

| | Powder rate (wt %) | | | | | |
|---|---|---|---|---|---|---|
| | Powder | | Properties | | | |
| | metallurgy | Iron powder | | | Air | |
| | cutting | for powder | | | perme- | |
| Ex. No. | powder | metallurgy | Packing | Strength | ability | Note |
| 3-01 | 100 | 0 | Very good | Normal | Good | |
| 3-02 | 90 | 10 | Good | Normal | Good | |
| 3-03 | 70 | 30 | Good | Good | Good | |
| 3-04 | 50 | 50 | Good | Good | Good | |
| 3-05 | 30 | 70 | Normal | Good | Good | |
| 3-06 | 10 | 90 | Normal | Good | Good | |
| 3-07 | 0 | 100 | Normal | Good | Good | |

### EXAMPLE 4

As the metal powder 4, cast iron cutting powder (machining chips) and iron powder for powder metallurgy were mixed in a ratio shown in the table below and evenly packed into a mold formed of a heat resisting steel with a carbon steel perforated plate 3 inserted and a die lubricant applied by applying vibration while leveling the top surface.

The mold having the perforated plate 3 packed with the metal powder 4 was sintered for 60 minutes in a furnace of a mesh belt type under cracked ammonia atmosphere at 1140° C.

The table below shows properties of the filter 2, prepared using the metal powder 4 of cast iron cutting powder (machining chips) and iron powder for powder metallurgy mixed in a weight ratio listed in the table.

| | Powder rate (wt %) | | | | | |
|---|---|---|---|---|---|---|
| | Cast | Iron | Properties | | | |
| | iron | powder | | | Air | |
| Ex. | cutting | for powder | | | perme- | |
| No. | powder | metallurgy | Packing | Strength | ability | Note |
| 4-01 | 100 | 0 | Very good | Very good | Good | |
| 4-02 | 90 | 10 | Very good | Very good | Good | |
| 4-03 | 70 | 30 | Good | Good | Good | |
| 4-04 | 50 | 50 | Good | Good | Good | |
| 4-05 | 30 | 70 | Normal | Good | Good | |
| 4-06 | 10 | 90 | Normal | Good | Good | |
| 4-07 | 0 | 100 | Normal | Good | Good | |

### EXAMPLE 5

As the metal powder 4, steel cutting powder (machining chips) of 20 to 40 mesh and iron powder for powder metallurgy were mixed in a ratio shown in the table below and evenly packed into a mold formed of a heat resisting steel with a carbon steel perforated plate 3 inserted and a die lubricant applied by applying vibration while leveling the top surface.

The mold having the perforated plate 3 packed with the metal powder 4 was sintered for 60 minutes in a furnace of a mesh belt type under cracked ammonia atmosphere at 1140° C.

The table below shows properties of the filter 2, prepared using the metal powder 4 of steel cutting powder (machining chips) and iron powder for powder metallurgy mixed in a weight ratio listed in the table.

| | Powder rate (wt %) | | | | | |
|---|---|---|---|---|---|---|
| | Steel | Iron powder | Properties | | | |
| | cutting | for powder | | | Air | |
| Ex. No. | powder | metallurgy | Packing | Strength | permeability | Note |
| 5-01 | 100 | 0 | Normal | Normal | Very good | |
| 5-02 | 90 | 10 | Normal | Normal | Very good | |
| 5-03 | 70 | 30 | Normal | Good | Very good | |
| 5-04 | 50 | 50 | Normal | Good | Very good | |
| 5-05 | 30 | 70 | Normal | Good | Good | |
| 5-06 | 10 | 90 | Normal | Good | Good | |
| 5-07 | 0 | 100 | Normal | Good | Good | |

EXAMPLE 6

As the metal powder 4, cast iron cutting powder (machining chips) and a pore forming agent were mixed in a ratio shown in the table below and evenly packed into a mold formed of a heat resisting steel with a stainless steel perforated plate 3 inserted and a die lubricant applied by applying vibration while leveling the top surface by applying a pressure of 50 to 1500□/□.

Normal wax was used as the pore forming agent.

The mold having the perforated plate 3 packed with the metal powder 4 was sintered for 60 minutes in a furnace of a mesh belt type under cracked ammonia atmosphere at 1140° C.

The table below shows properties of the filter 2, prepared using the metal powder 4 of cast iron cutting powder (machining chips) and the pore forming agent mixed in a weight ratio listed in the table.

| | Powder rate (wt %) | | Properties | | | |
|---|---|---|---|---|---|---|
| | Cast iron | Pore | | | Air | |
| | cutting | forming | | | perme- | |
| Ex. No. | powder | agent | Packing | Strength | ability | Note |
| 6-01 | 100 | 0 | Very good | Very good | Good | |
| 6-02 | 98 | 2 | Very good | Very good | Good | |
| 6-03 | 96 | 4 | Very good | Very good | Very good | |
| 6-04 | 94 | 6 | Very good | Very good | Very good | |
| 6-05 | 92 | 8 | Very good | Good | Very good | |
| 6-06 | 90 | 10 | Very good | Good | Very good | |
| 6-07 | 80 | 20 | Very good | Normal | Very good | |

### EXAMPLE 7

As the metal powder 4, stainless steel powder of 20 to 40 mesh and a sintering promoter were mixed in a ratio shown in the table below and evenly packed into a mold formed of a ceramic material with a stainless steel perforated plate 3 inserted by applying vibration while leveling the top surface by applying a pressure of 50 to 1500□/□.

Cu₃P was used as the sintering promoter.

The mold having the perforated plate 3 packed with the metal powder 4 was sintered for 60 minutes in a high temperature furnace of a pusher type under cracked ammonia atmosphere at 1230° C.

The table below shows properties of the filter 2, prepared using the metal powder 4 of stainless steel powder and the sintering promoter mixed in a weight ratio listed in the table.

| | Powder rate (wt %) | | Properties | | | |
|---|---|---|---|---|---|---|
| | stainless | | | | Air | Note |
| | steel | sintering | | | perme- | (sintering |
| Ex. No. | powder | promoter | Packing | Strength | ability | promoter) |
| 7-01 | 100 | 0 | Bad | Good | Good | Cu3P |
| 7-02 | 98 | 2 | Bad | Good | Good | |
| 7-03 | 96 | 4 | Bad | Very good | Good | |
| 7-04 | 94 | 6 | Bad | Very good | Good | |
| 7-05 | 92 | 8 | Bad | Very good | Very | |
| | | | | | good | |
| 7-06 | 90 | 10 | Bad | Very good | Very | |
| | | | | | good | |
| 7-07 | 80 | 20 | Normal | Very good | Very | |
| | | | | | good | |

### EXAMPLE 8

As the metal powder 4, a mixture powder of stainless steel powder of 20 to 40 mesh and processed powder thereof in a weight ratio of 50:50, and a sintering promoter were mixed in a ratio shown in the table below and evenly packed into a mold formed of a ceramic material with a stainless steel perforated plate 3 inserted by applying vibration while leveling the top surface.

Cu₃P was used as the sintering promoter.

The mold having the perforated plate 3 packed with the metal powder 4 was sintered for 60 minutes in a high temperature furnace of a pusher type under cracked ammonia atmosphere at 1230° C.

The table below shows properties of the filter 2, prepared using the metal powder 4 of the mixture powder of stainless steel powder of 20 to 40 mesh and processed powder thereof in a weight ratio of 50:50, and the sintering promoter mixed in a weight ratio listed in the table.

| | | | Properties | | | |
|---|---|---|---|---|---|---|
| | Powder rate (wt %) | | | | Air | Note |
| | Mixture | sintering | | | perme- | (sintering |
| Ex. No. | powder | promoter | Packing | Strength | ability | promoter) |
| 8-01 | 100 | 0 | Good | Normal | Very | Cu3P |
| | | | | | good | |
| 8-02 | 98 | 2 | Good | Normal | Very | |
| | | | | | good | |
| 8-03 | 96 | 4 | Good | Good | Very | |
| | | | | | good | |
| 8-04 | 94 | 6 | Good | Good | Very | |
| | | | | | good | |
| 8-05 | 92 | 8 | Good | Very good | Very | |
| | | | | | good | |
| 8-06 | 90 | 10 | Good | Very good | Good | |
| 8-07 | 80 | 20 | Good | Very good | Normal | |

### EXAMPLE 9

As the metal powder 4, a mixture of 92 wt % of a mixture powder of stainless steel powder of 20 to 40 mesh and processed powder thereof in a weight ratio of 50:50, and 8 wt % of a sintering promoter, and an organic pore forming agent (solid wax) were mixed in a ratio shown in the table below and evenly packed into a mold formed of a ceramic material with a stainless steel perforated plate 3 inserted by applying vibration while leveling the top surface by applying a pressure of 50 to 1500□/□.

The mold having the perforated plate 3 packed with the powder mixture was sintered for 60 minutes in a high temperature furnace of a pusher type under cracked ammonia atmosphere at 1230° C.

The table below shows properties of the filter 2, prepared using the metal powder 4 of the mixture of 92 wt % of the mixture powder of stainless steel powder of 20 to 40 mesh and processed powder thereof in a weight ratio of 50:50, and 8 wt % of the sintering promoter, and the organic pore forming agent (solid wax) mixed in a weight ratio listed in the table.

| | Powder rate (wt %) | | Properties | | | |
|---|---|---|---|---|---|---|
| | | Pore | | | Air | |
| | | forming | | | perme- | |
| Ex. No. | Mixture | agent | Packing | Strength | ability | Note |
| 9-01 | 100 | 0 | Good | Very good | Very good | |
| 9-02 | 98 | 2 | Good | Very good | Very good | |
| 9-03 | 96 | 4 | Good | Very good | Very good | |
| 9-04 | 94 | 6 | Very good | Very good | Very good | |
| 9-05 | 92 | 8 | Very good | Good | Very good | |
| 9-06 | 90 | 10 | Very good | Good | Very good | |
| 9-07 | 80 | 20 | Very good | Normal | Very good | |

### INDUSTRIAL APPLICABILITY

According to the present invention, it is possible to reduce production cost by preparing the metal powder used in the filter using machining chips. Also, since the powder is packed and sintered at a low pressure, it is possible to reduce density of the metal powder, to improve air permeability of the filter and to lighten the filter.

Particularly, by using cast iron machining chips, the sintering may be performed at a temperature of 1170° C. or less using a normal furnace of a mesh belt type, whereby it is possible to mass-produce the filter.

1-8. (canceled)

9. A method for producing a filter comprising metal powder sintered on a perforated plate used in a gas generating apparatus of a car airbag, the method comprising the steps of: preparing a perforated plate in a cylinder form by uniformly forming holes of 1 to 8 mm on a metal plate using a frame mold and rolling up the plate 1 to 2 times; preparing metal powder of 20 to 50 mesh by processing machining chips; placing the perforated plate in a mold and vibration packing the metal powder to be uniformly distributed; and sintering the metal powder at 1000 to 1350° C. for 15 to 120 minutes.

10. The method according to claim 9, further comprising the step of: applying a pressure of 50 to 1500 kg/cm² on the metal powder packed before the step of sintering.

11. The method according to claim 9, in which the metal powder comprises 50 to 70 wt % of stainless steel powder of 20 to 50 mesh and 30 to 50 wt % of a reclaimed powder prepared by processing machining chips of stainless steel.

12. The method according to claim 9, in which the metal powder comprises 0 to 99 wt % of iron powder for powder metallurgy of 20 to 50 mesh and 1 to 99 wt % of reclaimed powder prepared by processing steel cutting powder(machining chips).

13. The method according to claim 9, in which the metal powder comprises 10 to 90 wt % of iron powder for powder metallurgy of 20 to 50 mesh and 10 to 90 wt % of reclaimed powder prepared by processing cast iron cutting powder(machining chips).

14. The method according to claim 9, in which the metal powder comprises powder prepared by processing machining chips produced in the processing of powder metallurgy products to have a size of 20 to 50 mesh.

15. The method according to claim 9, in which the metal powder is sintered with a pore forming agent in an amount of 1 to 20 wt %, based on the total weight.

16. The method according to claim 9, in which the metal powder is sintered with Cu₃P as a sintering promoter in an amount of 1 to 30 wt %, based on the weight of the metal powder.
